(19) United States
(12) Patent Application Publication
(10) Pub. No.: US 2011/0045285 A1
(43) Pub. Date: Feb. 24, 2011

(54) TRANSPARENT CONDUCTIVE FILM

(75) Inventors: Takafumi SAIKI, Kanagawa (JP); Naoya Imamura, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Minato-ku (JP)

(21) Appl. No.: 12/858,777

(22) Filed: Aug. 18, 2010

(30) Foreign Application Priority Data
Aug. 19, 2009 (JP) 2009-190532

(51) Int. Cl. B32B 5/00; B32B 27/36

(52) U.S. Cl. 428/339; 428/480

(57) ABSTRACT

A transparent conductive film includes a polymer layer disposed on one of surfaces of a film base formed from polyester and biaxially stretched, and a transparent conductive layer disposed on the polymer layer. A difference between a refractive index η1 of the film base and a refractive index η2 of the polymer layer, |η1−η2| is set to at most 0.02. The polymer layer contains particles of metal oxide having a refractive index ηP of at least 1.80, and a binder holding the particles and having a refractive index ηB of at least 1.60. A mass ratio of the particles of metal oxide with respect to the binder is set to be more than 0% and equal to or less than 100%.

### FIELD OF THE INVENTION

The present invention relates to a transparent conductive film, and more specifically to a transparent conductive film including a film base formed from polyester and a conductive layer.

### BACKGROUND OF THE INVENTION

In recent years, demand for a transparent conductive film as a member to be used in the field of electrics and electronics has been increased more and more. The transparent conductive film is used, for example, as a transparent electrode of a flat panel display such as a liquid crystal panel and an electroluminescent (EL) panel, and a touch panel. The transparent conductive film is a multilayer film in which a conductive metal-oxide thin-film is disposed on a film base formed from transparent polymer. As the metal oxide, there are tin oxide, indium oxide, indium-tin composite oxide, zinc oxide, and the like.

As the film base, a polyethylene terephthalate (PET) film stretched in two directions intersecting with each other, namely, a so-called biaxially stretched PET film, as disclosed in Japanese Patent Laid-Open Publication No. 8-244186 (1996-244186), is widely used, since the biaxially stretched PET film is excellent in transparency, stability in size, chemical resistance, low hygroscopic property, electrical insulation property, and the like. Further, between the film base and the conductive layer is disposed a layer for imparting various functions to the conductive film in some cases. As such a so-called functional layer, there are an adhesive layer for increasing adhesion degree between the film base and the conductive layer, and a hard coat layer for imparting scratch resistance to the conductive film, as disclosed in Japanese Patent Laid-Open Publications Nos. 8-244186 (1996-244186) and 2000-094592.

Incidentally, during production of the PET film, an oligomer which is a compound having a low degree of polymerization is generated in the PET film as a result of a side reaction. Cyclic trimer is representative of such an oligomer. It is known that, the oligomer inevitably exists in the PET film, and upon heating of the PET film, the oligomer exuding from an inside of the PET film appears by deposition on a surface of the PET film. At the time of forming the conductive layer, or at the time of processing the formed conductive layer, the PET film as the film base, or a portion formed from PET which functions as the film base is heated in many cases. Accordingly, in some cases, the transparent conductive film including the PET film as the film base has the following problems which are caused due to the deposition of the oligomer upon heating of the PET film. For example, there are caused defect in adhesion between the film base and the conductive layer, and defect in adhesion between the film base and the functional layer disposed between the film base and the conductive layer. Further, white spots appear on the transparent conductive film and make the transparent conductive film cloudy, thus resulting in decrease in transparency of the transparent conductive film. Furthermore, the conductivity of the transparent conductive film does not achieve a desired level. Note that, the oligomer also exists in various kinds of polyester films other than the PET film, and upon heating of the polyester film, the oligomer exuding from an inside of the polyester film appears by deposition on a surface of polyester film, as in the case of the PET film.

Consequently, according to Japanese Patent Laid-Open Publication No. 2005-135586, ultraviolet (UV) ray is preliminarily irradiated to a surface of a polyester film before being provided with an adhesive layer, and then an adhesive layer and a conductive layer are sequentially disposed on the polyester film after being subjected to the UV ray irradiation, thereby preventing deposition of the oligomer. Additionally, according to Japanese Patent Laid-Open Publication No. 2001-135150, polyester before being formed into a film is heated up to at least 180° C. under a pressurized inert gas atmosphere for at least 12 hours, and thereby preliminarily decreasing an amount of the cyclic trimer before the formation of the film.

As described above, the transparent conductive film has a multilayer film structure in which a plurality of layers formed from different materials are stacked on one another. In such a multilayer film structure, light is reflected on an interface between the layers or an interface between an outer-most layer and air, and the reflected light interferes with each other to cause a phenomenon in which the light seems rainbow in many cases. This phenomenon is so-called rainbow unevenness.

Consequently, according to U.S. Pat. No. 7,541,087 (corresponding to Japanese Patent Laid-Open Publication No. 2007-326357) , there are provided a film base formed from polyester, a first layer disposed on the film base, and a second layer disposed on the first layer. The first layer contains particles having any one of tin oxide, indium oxide, zirconium oxide, and titanium oxide as its main component, and a binder. The difference in refractive index between the film base and the first layer and the difference in refractive index between the film base and the second layer are respectively set to a predetermined value or less. Thus, occurrence of rainbow unevenness is prevented. In this way, the invention disclosed in U.S. Pat. No. 7,541,087 is effective to some extent in preventing occurrence of rainbow unevenness. However, as the amount of metal oxide to be used for preventing occurrence of rainbow unevenness is increased, the transparency of the conductive film is decreased, unfavorably.

Further, as described above, according to Japanese Patent Laid-Open Publications No. 2005-135586 and 2001-135150, the PET film or the PET before being formed into a film, which is at the stage before being providing with the conductive layer and the functional layer such as the adhesive layer, is subjected to a given treatment. Namely, the PET film itself before being provided with the conductive layer and the functional layer is subjected to property-modifying treatment for preventing deposition of the oligomer. The optical properties such as transparency and color of the PET film vary depending on conditions of the above-described property-modifying treatment.

In order to produce the transparent conductive film having a desired quality as a final product by using the PET film having various optical properties as the film base, it is necessary to adjust a refractive index of the conductive layer and a refractive index of the functional layer such as the adhesive layer for the purpose of adjusting a refractive index of the transparent conductive film. Additionally, it is necessary to set the thickness of layers other than the film base arbitrarily for the purpose of adjusting the refractive index thereof. However, adjusting the thickness and the refractive index of each of the layers other than the film base in accordance with the optical properties of the film base is not effective for productivity. Otherwise, the transparent conductive film having desired optical properties cannot be obtained in some cases. Additionally, as the countermeasure against occurrence of rainbow unevenness, it is necessary to control the refractive index and the thickness of the layers other than the film base in accordance with the optical properties of the film base, and it is also necessary to control the optical properties of the layers other than the film base for the purpose of preventing occurrence of rainbow unevenness. However, controlling both of them in the layers other than the film base is difficult. In view of the above, deposition of the oligomer on the polyester as the film base is preferably prevented by the layers other than the film base, as in the case of preventing occurrence of rainbow unevenness.

As describe above, as the amount of metal oxide to be used for preventing occurrence of rainbow unevenness is increased in the layers other than the film base, the transparency of the conductive film is decreased. Further, in the case where the properties of the film base itself or the properties of the polymer for forming the film base are modified, it is required to control the optical properties of the layers to be disposed on the film base in accordance with the optical properties of the film base. The target to be controlled includes the thickness and refractive index of the layers to be disposed on the film base.

### SUMMARY OF THE INVENTION

In view of the above, an object of the present invention is to provide a transparent conductive film capable of preventing occurrence of rainbow unevenness without decreasing transparency thereof and preventing deposition of oligomer on a film base by layers other than the film base.

In order to achieve the above and other objects, a transparent conductive film of the present invention includes a film base formed from polyester and biaxially stretched, a polymer layer formed on one of surfaces of the film base, and a transparent conductive layer formed on the polymer layer. The polymer layer contains particles of metal oxide having a refractive index ηP of at least 1.80 and a binder holding the particles and having a refractive index ηB of at least 1.60. A mass ratio of the particles with respect to the binder is at most 100%. A difference between a refractive index η1 of the film base and a refractive index η2 of the polymer layer is at most 0.02.

Preferably, the metal oxide includes tin oxide and antimony oxide, and when mass of the tin oxide is denoted by M1 and mass of the antimony oxide is denoted by M2, a content of the antimony oxide with respect to the tin oxide obtained by (M2/M1)×100 is more than 0 mass % and equal to or less than 5 mass %.

A thickness of the polymer layer is preferably in a range of {500/(4×η2)}nm or more and {600/(4×η2)}nm or less. A glass transition temperature Tg of polymer as the binder is preferably at least 90° C.

In the transparent conductive film of the present invention, it is possible to prevent occurrence of rainbow unevenness without decreasing transparency thereof and prevent deposition of the oligomer on the film base by the layers other than the film base.

### DESCRIPTION OF THE DRAWINGS

One with ordinary skill in the art would easily understand the above-described objects and advantages of the present invention when the following detailed description is read with reference to the drawings attached hereto:

FIG. 1 is a cross sectional view of a transparent conductive film according to a first embodiment of the present invention;

FIG. 2 is a cross sectional view of a transparent conductive film according to a second embodiment of the present invention; and

FIG. 3 is a schematic view illustrating a transparent conductive film producing apparatus.

### DESCRIPTION OF THE PREFERRED EMBODIMENTS

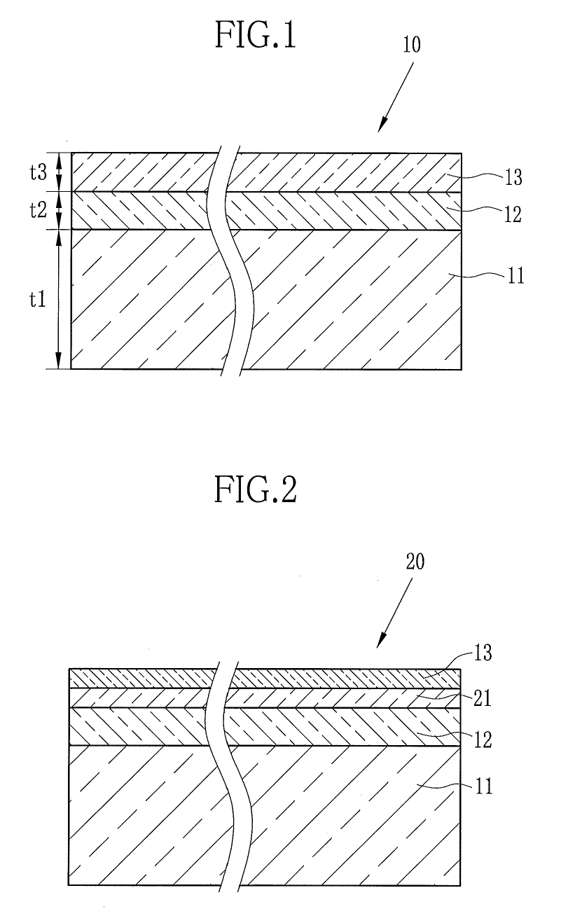

Hereinafter, preferred embodiments of the present invention are described in detail. However, the present invention is not limited thereto. As shown in FIG. 1, a transparent conductive film (hereinafter abbreviated as conductive film) 10 of a first embodiment of the present invention includes a film base 11 formed from polyester and biaxially stretched, a polymer layer 12 formed on one of surfaces of the film base 11, and a conductive layer 13 formed on the polymer layer 12 and having conductive properties. Namely, the conductive layer 13 is formed on the polymer layer 12 at the side opposed to the film base 11.

The polymer layer 12 contains a plurality of particles of metal oxide having a refractive index ηP of at least 1.80, and a binder holding the particles and having a refractive index ηB of at least 1.60. Since the binder having such a high refractive index ηB is used, mass ratio of the particles with respect to the binder is suppressed to be low. When mass of the particles is denoted by MP and mass of the binder is denoted by MB, the mass ratio of the particles with respect to the binder, namely, percentage obtained by (MP/MB)×100 is set to at most 100%, concretely, more than 0% and equal to or less than 100%. Further, in the conductive film 10, the difference between a refractive index η1 of the film base 11 and a refractive index η2 of the polymer layer 12, |η1−η2| is set to at most 0.02. Due to the formation of the conductive film 10 described above, it is possible to prevent occurrence of rainbow unevenness without decreasing the transparency of the conductive film 10, and it is also possible to prevent deposition of the oligomer, in particular, the circular trimer, on the film base 11 by the polymer layer 12.

In a conventional method in which polyester before being formed into a film is heated, or in a conventional method in which a film base formed from polyester before being provided with a conductive layer is subjected to treatment for modifying the properties thereof, it is necessary to adjust the thickness, refractive index, and the like of the layers formed on the film base with high precision for the purpose of preventing rainbow unevenness. In contrast, according to the present invention, since the deposition of the oligomer is prevented by the polymer layer 12, it is sufficient to adjust the refractive index of the polymer layer 12 with taking into consideration of the rainbow unevenness and transparency. Further, due to the formation of the conductive film 10 described above of the present invention, it is possible to prevent occurrence of rainbow unevenness without decreasing the transparency of the conductive film 10. The film base 11, the polymer layer 12, and the conductive layer 13 are described in detail below.

[Film Base]

The film base 11 as a main body of the conductive film 10 is polyester formed into a film by a melt extrusion method and stretched in two directions intersecting with each other, namely biaxially stretched. The two directions intersecting with each other are preferably perpendicular to each other. The biaxial stretching may be performed before or after the formation of the polymer layer 12 and the conductive layer 13. Alternatively, the biaxial stretching may be performed such that stretching is performed in one of the two directions before the formation of the polymer layer 12 and the conductive layer 13 and stretching is performed in the other of the two directions after the formation of the polymer layer 12 and the conductive layer 13. Degree of molecular orientation in two directions of the film base 11 is controlled by the biaxial stretching, and thereby the mechanical strength of the film base 11 is increased. Further, the refractive index of the film base 11 also can be adjusted by the biaxial stretching.

The stretching ratio is not particularly limited. However, the stretching ratio in one direction is preferably 1.5 to 7 times, and more preferably 2 to 5 times. When stretching is performed with the above stretching ratio, mechanical strength of the film base 11 is further increased.

The polyester is not particularly limited, and may be PET, polyethylene naphthalate (PEN), polybutylene terephthalate (PBT), or polybutylene naphthalate (PBN), for example. Among them, PET is especially preferably used from the viewpoint of its mechanical strength and cost.

A thickness t1 of the film base 11 is preferably in a range of 50 μm or more and 300 μm or less. The film base 11 having the thickness t1 within the above range exhibits high transparency, and is lightweight and excellent in handleability. The thickness t1 may be controlled in a melt extrusion process of the polymer. Alternatively, the thickness t1 may be controlled by adjustment of the stretching ratio of the film base 11.

Note that, the film base 11 may contain various kinds of additives such as UV absorber and the like. The kind of UV absorber, the amount of the UV absorber to be added, and how to add the UV absorber are described in Japanese Patent Laid-Open Publication No. 2007-326357, and the description of this publication is applicable to the present invention.

The surface of the film base 11 may be subjected to corona discharging treatment. Due to the corona discharging treatment, the surface of the film base 11 becomes hydrophilic. As a result, it is possible to increase wettability of the coating liquid for forming the polymer layer 12 to the surface of the film base 11, and thereby the adhesion degree between the film base 11 and the polymer layer 12 can be increased.

[Polymer Layer]

The polymer layer 12 includes particles of metal oxide and the binder holding the particles, and thereby the rainbow unevenness is prevented. Since the binder having the refractive index ηB larger than that of conventional binders is used as described above, the mass ratio of the metal oxide for constituting the particles with respect to the binder falls within a range of more than 0 mass % and 100 mass % or less, which is lower than ever before. Therefore, occurrence of rainbow unevenness can be prevented without decreasing the transparency of the polymer layer 12. Accordingly, as the refractive index ηP of the metal oxide for constituting the particles is decreased, it is preferred to increase the refractive index ηB of the binder to be used. The refractive index ηP of the metal oxide for constituting the particles is preferably at least 1.70, more preferably in a range of 1.80 or more and 2.80 or less, and most preferably in a range of 1.90 or more and 2.80 or less. Note that, each value of the refractive index is that of a refractive index of light having a wavelength of 550 nm in this specification. The mass ratio of the metal oxide for constituting the particles with respect to the binder is more preferably in a range of 50 mass % or more and 100 mass % or less, and most preferably in a range of 50 mass % or more and 90 mass % or less.

The metal oxide for constituting the particles is, for example, titanium oxide, tin oxide, indium oxide, zinc oxide, zirconium oxide, cerium oxide, or the like. Among them, tin oxide is preferably used. More preferably, the metal oxide includes tin oxide and antimony oxide, namely, each of the particles includes both of tin oxide and antimony oxide. Still more preferably, the particles of metal oxide include antimony-doped tin oxide. When mass of the tin oxide is denoted by M1 and mass of the antimony oxide is denoted by M2, the mass ratio of the antimony oxide with respect to the tin oxide, namely, percentage (unit; %) obtained by (M2/M1)×100 is preferably more than 0% and equal to or less than 5%. When the content of antimony oxide with respect to tin oxide falls within the above range, it is possible to obtain the transparent and colorless conductive film 10, while increasing antistatic properties of the conductive film 10 by the polymer layer 12 and preventing coloring of the polymer layer 12. Additionally, when the content of antimony oxide with respect to tin oxide falls within the above range, it is possible to form the polymer layer 12 having high adhesion degree to the conductive layer 13.

It is possible to prevent aggregation of the particles in the polymer layer 12 by taking into consideration of the diameter and kind of the particles. The average diameter of the particles is preferably in a range of 5 nm or more and 200 nm or less. When the average diameter of the particles is at most 200 nm, it is possible to more surely prevent decrease in transparency of the polymer layer 12. Further, when the average diameter of the particles is at least 5 nm, it is possible to more surely prevent aggregation of the particles, thereby preventing decrease in the transparency of the polymer layer 12 which is to be caused by the aggregation of the particles. The average diameter of the particles is more preferably in a range of 10 nm or more and 100 nm or less, and most preferably in a range of 15 nm or more and 70 nm or less. Note that, the average diameter of the particles is obtained by arbitrarily selecting 50 particles and imaging the 50 particles with use of Scanning Electron Microscope (SEM), and then measuring the diameter of circle whose area is the same as that of each of the particles. The average diameter of the 50 circles is considered as the average diameter of the 50 particles.

Transparent polymer is used as the binder. Preferable polymer is polyester, acrylic resin, polyurethane, or the like. The polyester is obtained from naphthalenedicarboxylic acid, tetrabromoterephthalic acid, tetrachloroterephthalic acid, dibromo acid, or the like. The acrylic resin is obtained from dichlorostyrene, bromostyrene, dibromostyrene, tribromophenyl methacrylate, tribromophenyl acrylate, p-bromobenzyl acrylate, p-bromobenzyl methacrylate, dibromobenzyl acrylate, dibromobenzyl methacrylate, trichlorophenyl methacrylate, trichlorophenyl acrylate, or the like. The polyurethane is obtained from diol component such as tetrabromobisphenol A derivatives and tetrachlorobisphenol A derivatives.

The polymer to be used as the binder preferably has a glass transition temperature Tg of at least 90° C., such that deposition of the oligomer on the film base 11 can be prevented. In general, diffusion of oligomer hardly occurs in the polymer in the state of glass, and easily occurs in the polymer in the state of rubber due to the temperature increase. Therefore, when the polymer having the glass transition temperature Tg higher than that of the polyester as the film base 11 is used as the binder of the polymer layer 12, it is possible to prevent deposition of the oligomer. For example, in the case where the film base 11 is formed from PET, the polymer having the glass transition temperature Tg higher than that of PET is preferably used as the binder of the polymer layer 12. From the viewpoint of the above, in this embodiment, the polymer having the glass transition temperature Tg of at least 90° C. is used as the binder. Polyester and polyurethane are preferably used as the preferable polymer, since polyester and polyurethane respectively have the glass transition temperature Tg of at least 90° C. The polyester and polyurethane are described hereinbelow.

The polyester is a general term for the polymers having an ester bond in the main chain, and is generally obtained by the reaction between polycarboxylic acid and polyol. The polycarboxylic acid is, for example, fumaric acid, itaconic acid, adipic acid, sebacic acid, terephthalic acid, isophthalic acid, naphthalenedicarboxylic acid, and sulfoisophthalic acid. The polyol is, for example, ethylene glycol, propylene glycol, 1,4-butanediol, 1,6-hexanediol, glycerin, hexanetriol, neopentyl glycol, polyethylene glycol, polypropylene glycol, and polytetramethylene glycol. Since the polyester included in the film base 11 and the polyester included as the binder in the polymer layer 12 are of the same type, the adhesion degree between the film base 11 and the polymer layer 12 formed on the film base 11 can be enhanced more.

The polyurethane is a general term for the polymers having an urethane bond in the main chain, and is generally obtained by the reaction between polyisocyanate and polyol. The polyisocyanate is, for example, TDI, MDI, NDI, TODI, HDI, and IPDI. The polyol is, for example, ethylene glycol, propylene glycol, glycerin, and hexanetriol. Additionally, the isocyanate can be polymer with increased molecular weight, made by a chain extension process to polyurethane polymer obtained by the reaction between the polyisocyanate and the polyol. The polyisocyanate, polyol, and chain extension process as described above are described thoroughly in “Polyurethane Handbook” (edited by Keiji Iwata, published by Nikkan Kogyo Shinbunsha, 1987), for example, and the description of this publication can be adapted to the present invention.

The refractive index ηB of the binder is preferably at least 1.60, and more preferably in a range of 1.60 or more and 2.50 or less, and most preferably in a range of 1.60 or more and 2.00 or less.

Additionally, the polymer layer 12 may further include various kinds of particles and additives described in [0043] to [0047] of Japanese Patent Laid-Open Publication No. 2007-326357.

A thickness t2 of the polymer layer 12 having a refractive index η2, which is different from the refractive index η1 of the film base 11 by at most 0.02, is set within a range of {500/(4×η2)}nm or more and {600/(4×η2)}nm or less. Thereby, it is possible to more surely prevent occurrence of rainbow unevenness.

[Conductive Layer]

The material for forming the conductive layer 13 is not especially limited as long as the material has both of transparency and conductivity. The material preferably used is a multi-layer structure or a single-layer structure of indium oxide, tin oxide, zinc oxide, indium-tin composite oxide, tin-antimony composite oxide, zinc-aluminum composite oxide, indium-zinc composite oxide, silver and silver alloy, copper and copper alloy, gold, and the like, for example. Among them, from the viewpoint of its environmental stability and circuit processability, the indium-tin composite oxide or tin-antimony composite oxide is more preferably used.

A thickness t3 of the conductive layer 13 is preferably in a range of 4 nm or more and 800 nm or less. When the thickness t3 of the conductive layer 13 is set to at least 4nm, the conductive layer 13 can be more surely held in the form of a continuous film, and can exhibit preferable conductivity more surely. Additionally, when the thickness t3 of the conductive layer 13 is set to at most 800 nm, it is possible to prevent more surely decrease in transparency of the conductive layer 13. The thickness t3 of the conductive layer 13 is more preferably in a range of 5 nm or more and 500 nm or less.

Next, a second embodiment of the present invention is described hereinbelow by referring to FIG. 2. In FIG. 2, the same components as those of the transparent conductive film 10 of the first embodiment are denoted by the same reference numerals used in FIG. 1 respectively, and the explanation thereof will be omitted. A transparent conductive film 20 of the second embodiment includes the film base 11, the polymer layer 12, the conductive layer 13, and a hard coat layer 21 for enhancing rub resistance of the conductive film 20. Note that, although the conductive layer 13 is formed on the hard coat layer 21 formed on the polymer layer 12 in this embodiment, other functional layers may be formed instead of the hard coat layer 21. Other functional layers are, for example, an adhesive layer for increasing adhesion degree between the polymer layer 12 and the conductive layer 13, a filler-containing layer for preventing Newton's rings in the case where the transparent conductive film 20 is applied to a touch panel.

The hard coat layer 21 is preferably formed from either energy curable polymer or thermosetting polymer. Note that, the energy curable polymer is hardened when being exposed to activation energy rays, and the thermosetting polymer is hardened when being heated.

As the energy curable polymer and the thermosetting polymer, the materials described in [0059] to [0063] of Japanese Patent Laid-Open Publication No. 2007-326537 may be used.

The refractive index of the hard coat layer 21 is preferably in a range of 1.62 or more and 1.68 or less. The hard coat layer 21 having such a high refractive index can be obtained by adding inorganic particles to the selected polymer. Since the inorganic particles have the refractive index as high as 1.6 to 2.7 generally, when the inorganic particles having such a high refractive index are added to the desired energy curable polymer or thermosetting polymer, it is possible to obtain the hard coat layer 21 having a high refractive index. The hard coat layer 21 preferably has the thickness in a range of 1 μm or more and 10 μm or less. In this thickness range, the physical functions such as optical function and rub resistance of the hard coat layer 21 become adequate, and the adhesion degree between the hard coat layer 21 and the polymer layer 12 and the adhesion degree between the hard coat layer 21 and the conductive layer 13 are further enhanced.

[Production Method]

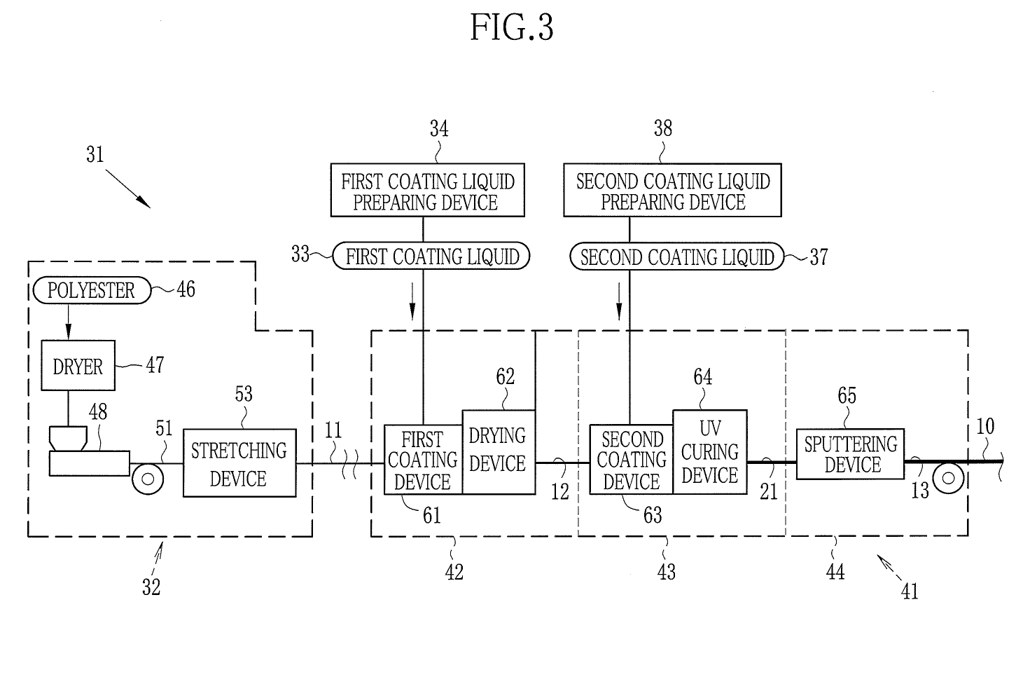

A production method of the conductive films 10 and 20 is described hereinbelow by referring to FIG. 3. The conductive film 10 is equivalent to the conductive film 20 not having the hard coat layer 21. Therefore, the explanation is made as to the production method of the conductive film 20.

As shown in FIG. 3, a conductive film producing apparatus 31 includes a film base forming unit 32 for forming the film base 11, a first coating liquid preparing device 34 for preparing a first coating liquid 33, a second coating liquid preparing device 38 for preparing a second coating liquid 37, and a film producing unit 41 for forming the conductive film 20. The first coating liquid 33 is used to form the polymer layer 12. The second coating liquid 37 is used to form the hard coat layer 21. The conductive film 20 consists of the film base 11, the first coating liquid 33, and the second coating liquid 37. The film producing unit 41 includes a polymer layer forming section 42, a hard coat layer forming section 43, and a conductive layer forming section 44. The polymer layer forming section 42 forms the polymer layer 12 on the film base 11. The hard coat layer forming section 43 is disposed in the downstream side from the polymer layer forming section 42 in a moving diction of the film base 11, and forms the hard coat layer 21 on the polymer layer 12. The conductive layer forming section 44 is disposed in the downstream side from the hard coat layer forming section 43 in the moving diction of the film base 11, and forms the conductive layer 13 on the hard coat layer 21 to produce the conductive film 20. Note that, in the case where the conductive layer 13 is directly formed on the polymer layer 12, the hard coat layer forming section 43 is omitted, and the film base 11 is directly guided from the polymer layer forming section 42 to the conductive layer forming section 44.

In the film base forming unit 32, the raw material of the film base 11 such as polyester 46 in the form of pellet, for example, is introduced to a dryer 47 and dried therein. Then, the polyester 46 in the form of pellet is introduced to a melt extruder 48 and extruded to be in the form of film. The polyester 46 in the form of film is hereinafter referred to as a base material 51. The base material 51 is guided to a stretching device 53.

The stretching device 53 is provided with a temperature adjuster (not shown) for adjusting the temperature of the base material 51 at a predetermined level. Due to the temperature adjuster, while the base material 51 is conveyed, the temperature of the base material 51 is increased or decreased to achieve a predetermined level at a predetermined timing.

In the stretching device 53, performed is a stretching process in which tension is applied to the base material 51 in a predetermined direction while the base material 51 is conveyed. The stretching process consists of a first stretching process and a second stretching process. In the first stretching process, the base material 51 is stretched in a conveying direction thereof (hereinafter referred to as MD direction). In the second stretching process, the base material 51 is stretched in the width direction thereof (hereinafter referred to as TD direction) such that the width of the base material 51 is increased. The base material 51 subjected to both of the first and second stretching processes becomes the film base 11. After the second stretching process, a heat fixation process in which the base material 51 is heated such that molecular orientation in the base material 51 is fixed, or a relaxation process in which the tension applied to the base material 51 in the TD direction is relaxed to decrease the residual strain in the base material 51 may be performed. Alternatively, a well-known simultaneous biaxial stretching device may be included in the stretching device 53 such that the first stretching process and the second stretching process are performed at the same time.

Note that, each of the conveying method and the stretching method of the base material 51 in the stretching device 53 is not especially limited, and well-known methods may be applicable to the present invention. For example, in the first stretching process, two rollers are used to convey the base material 51 such that there is difference in the peripheral velocity between the two rollers. Concretely, the peripheral velocity of the downstream one of the two rollers is set to be faster than that of the upstream one of the two rollers. Thereby, the base material 51 is stretched in the MD direction. It is possible to control the stretching ratio of the base material 51 in the MD direction by adjusting the peripheral velocity of each of the two rollers. In the second stretching process, a stretching device provided with clips, chains, and rails, all of which are not shown in the drawing, can be used. The clips are used as holding members for holding side ends of the base material 51 so as to convey the base material 51. Each of the chains is provided with the clips and moves endlessly. The rail is used to decide the track of the chain. In this case, the rail is provided with a shift mechanism (not shown in the drawing). The base material 51 is introduced to the stretching device 53. When the base material 51 reaches a predetermined position in the stretching device 53, each of the side ends of the base material 51 is held by the clip. The shift mechanism moves the rail in the width direction of the base material 51, and thereby the chain shifts. Each of the clips on the chain, which holds the side end of the base material 51, moves in the width direction of the base material 51, and thereby tension is applied to the base material 51 in the width direction. The stretching ratio of the base material 51 in the TD direction can be changed by controlling the shift of the chain.

The method of forming the film base 11 is not limited to the above method, and a well-known polymer film forming unit may be used. For example, there may be used a common polyester film forming unit described in “PET film-stretching technique, properties, evaluation, advanced function, and application development-” published by TECHNICAL INFORMATION INSTITUTE CO., LTD, 1990. In the case where the film base 11 is formed from the polyester, a well-known sequential biaxial stretching method or a well-known simultaneous biaxial stretching method is preferably performed.

Note that, in this embodiment, the film base 11 before being introduced to the polymer layer forming section 42 is subjected to surface treatment with use of a corona discharging treatment device (not shown).

In the first coating liquid preparing device 34, the first coating liquid 33 is prepared from the particles of metal oxide, the binder, and a liquid ingredient. The particles of metal oxide are dispersed into the liquid ingredient, and the binder is dissolved into the liquid ingredient.

The first coating liquid 33 prepared in the first coating liquid preparing device 34 is applied to the film base 11 by a first coating device 61 of the polymer layer forming section 42, to be a coating layer on the film base. Although well-known bar coating is used as the coating device in this embodiment, the coating device is not limited thereto. Well-known various kinds of coating devices may be used to apply the first coating liquid 33 to the film base 11. A drying device 62 for drying the coating layer of the first coating liquid 33 is disposed in the downstream side from the first coating device 61 in the moving direction of the film base 11. The coating layer of the first coating liquid 33 is dried by the drying device 62 and becomes the polymer layer 12.

In the second coating liquid preparing device 38, the second coating liquid 37 containing UV curable resin is prepared. The prepared second coating liquid 37 is sent to the hard coat layer forming section 43, and applied to the polymer layer 12 formed on the film base 11 which is guided from the polymer layer forming section 42, to be a coating layer on the polymer layer 12. Although the bar coating is also used as a second coating device 63 in the hard coat layer forming section 43, the second coating device 63 is not limited thereto, and well-known various kinds of coating devices may be used to apply the second coating liquid 37 to the polymer layer 12 formed on the film base 11. A UV curing device 64 is disposed in the downstream side from the second coating device 63. The UV curing device 64 is used to irradiate the coating layer of the second coating liquid 37 with UV rays such that the coating layer is hardened. Accordingly, the coating layer of the second coating liquid 37 is hardened by the UV curing device 64 and becomes the hard coat layer 21.

The film base 11 on which the polymer layer 12 and the hard coat layer 21 are formed is guided to the conductive layer forming section 44. The conductive layer forming section 44 is provided with a sputtering device 65 for forming the conductive layer 13 on the hard coat layer 21 by sputtering. However, the method of forming the conductive layer 13 is not limited to the sputtering used in this embodiment, and may be a well-known method such as a vacuum deposition method, a chemical vapor deposition (CVD) method, an ion plating method, and a spraying method.

The conductive film 20 and the conductive film 10 can be produced by the above method.

Hereinafter, Examples 1 to 4 of the present invention, and Comparative Examples 1 to 3 for comparison with the present invention are described.

### EXAMPLE 1

The conductive film 10 was produced by the conductive film producing apparatus 31. Note that, the conductive film producing apparatus 31 was not provided with the hard coat layer forming section 43.

Polyethylene terephthalate (PET), obtained by polycondensation using germanium (Ge) as a catalyst, with intrinsic viscosity of 0.66, was dried by the dryer 47, until the water content reached 50 ppm or less. After being dried, the PET was extruded by the melt extruder 48 to be the base material 51 in the form of film. The melt extruder 48 was provided with a heater for melting the PET, a die for extruding the melted PET into the form of film, and a chill roll disposed in the downstream side from the die in the extruding direction of the PET. The chill roll was a cooling roller having a cooling mechanism for cooling the peripheral surface thereof. Upon contact with the peripheral surface of the chill roll, the base material 51 was cooled. The temperature of the heater of the melt extruder 48 was kept approximately constant within a range of 280° C. to 300° C. The PET was melted by the heater, and extruded from the die to the chill roll to which static electricity was applied. Thereby, the base material 51 as an amorphous base material was obtained. The amorphous base material 51 was conveyed to the stretching device 53 disposed in the downstream side from the melt extruder 48 in the moving direction of the base material 51.

In the stretching device 53, the first stretching process for stretching the base material 51 in the MD direction and the second stretching process for stretching the base material 51 in the TD direction after the first stretching process were performed, to obtain the film base 11. In the first stretching process, the base material 51 was stretched such that the length of the base material 51 became 3.3 times as large as that before being stretched. In the second stretching process, tension was applied to the base material 51 in the width direction, such that the width of the base material 51 became 3.8 times as large as that before being applied with the tension. The thickness of the obtained film base 11 was 125 μm.

One of the surfaces of the film base 11 was subjected to the corona discharging treatment under the condition of 276 j/m².

The film base 11 after being subjected to the corona discharging treatment was guided to the polymer layer forming section 42, and the first coating liquid 33 having the following composition A was applied to the film base 11, to be the coating layer on the film base 11. The amount of the first coating liquid 33 applied to the film base 11 was 7.1×10⁻⁶m³ (corresponding to 7.1 cc) per square meter area.

<First Coating Liquid 33 Having Composition A>

| | |
|---|---|
| Polyester (binder component) having a refractive index of | 57.63 pts. mass |
| at least 1.60 (manufactured by Goo Chemical CO, Ltd., trade name: | |
| Plas coat Z-687, solid content of 25%) | |
| Compound having a plurality of carbodiimide structures | 28.31 pts. mass |
| (manufactured by Nisshinbo Chemical Inc., trade name: Carbodilite | |
| V-02-L2, solid content of 40%) | |
| Surfactant A (manufactured by NOF CORPORATION, aqueous | 12.68 pts. mass |
| solution containing 1% of Rapizol B-90, anionic) | |
| Surfactant B (manufactured by Sanyo Chemical Industries, | 15.49 pts. mass |
| Ltd., aqueous solution containing 1% of Naroacty CL-95, nonionic) | |
| Aqueous dispersion in which acicular composite metal oxide | 48.55 pts. mass |
| of tin dioxide and antimony is dispersed in water (manufactured | |
| by ISHIHARA SANGYO KAISYA, LTD., trade name: FS-10D, ratio of | |
| longer-axis length/shorter-axis length of 25, content of | |
| antimony oxide of 3.5%, solid content of 20%) | |

Distilled water added such that total amount of the first coating liquid 33 became 1000 parts by mass.

The coating layer of the first coating liquid 33 was heated at the temperature of 155° C. to be dried by the drying device 62 for 1 minute, thereby obtaining the polymer layer 12.

A sample was taken from the film base 11 on which the polymer layer 12 was formed, and the thickness t2 of the polymer layer 12 of the sample was measured using a transmission electron microscope (manufactured by JEOL Ltd., trade name: JEM2010) with magnification of 200,000 times. The thickness t2 of the polymer layer 12 was 92 nm.

The refractive index of the polymer layer 12 of the sample was measured by the following method. At first, the first coating liquid 33 having the composition A was applied to a silicon wafer commercially available such that the thickness of the first coating liquid 33 after being dried became 3 to 4 nm, to obtain the coating layer on the silicon wafer. The coating layer was heated at the temperature of 105° C. to be dried for 10 minutes. Thus, the sample for measuring the refractive index was made. Then, the sample was set to a refractive index measuring device (manufactured by Sairon Technology, Inc., trade name: SPA-4000) so as to measure the refractive index of the coating layer of the first coating liquid 33 at wavelengths of 660 nm and 850 nm by a prism coupler method. Next, the value of each of the wavelengths, namely 660 nm and 850 nm, and the measured value of the refractive index at each of the wavelengths of 660 nm and 850 nm were respectively substituted into Celmaire formula expressed by the following formula (1) to calculate constants A and B. Thereafter, the refractive index at the wavelength of 550 nm was calculated from the constants A and B. Note that, in the Formula (1), “λ” represents a wavelength (nm) at which the refractive index is measured, and “n” represents a refractive index measured at the wavelength. The refractive index at the wavelength of 550 nm thus obtained was 1.65.

n2−1=Aλ2/(λ2−B) Formula (1)

The film base 11 on which the polymer layer 12 was formed was guided to the sputtering device 65 provided in the conductive layer forming section 44 so as to form an indium tin oxide (ITO) layer as the transparent conductive layer 13 on the polymer layer 12. Direct current (DC) sputtering was utilized as the sputtering device 65. A sputtering target in which the ratio of indium to tin was 90 to 10 was used. Pressure in a vacuum chamber of the sputtering device 65 was preliminarily set to 10⁻³ Pa, and while mixed gas of argon (Ar) and oxygen (O²) was introduced to the vacuum chamber, sputtering was performed under the pressure of 5×10⁻¹ Pa. The refractive index of the conductive layer 13 thus obtained was 2.05, and the thickness t3 thereof was 30 nm.

The obtained conductive film 10 was evaluated as to the transparency, adhesion degree between the film base 11 and the polymer layer 12, whether or not rainbow unevenness occurred, and whether or not deposition of oligomer occurred.

1. Evaluation of Transparency

Total light transmittance and the amount of change in haze before and after heating the conductive film 10 were measured. The transparency of the conductive film 10 was evaluated based on the measurement result. The total light transmittance and the amount of change in haze were measured using a haze meter (manufactured by Nippon Denshoku Industries Co., Ltd., trade name: NDH-2000) in conformance with JIS-K-7105.

The amount of change in haze (unit; %) before and after heating the conductive film 10 was measured as follows. The haze before and after heating the conductive film 10 under a predetermined condition was measured respectively. Namely, the haze with/without heating the conductive film 10 was measured respectively. The amount of change in haze was obtained by using a formula expressed by |H2−H1|/|H1×100, in which H1 was the haze before the heating and H2 was the haze after the heating.

For the purpose of measuring the amount of change in haze, a sample was taken from the conductive film 10, and the sample was put into an oven having an inside temperature set at 150° C. to be kept therein for 10 minutes during the heating. Then, the sample was taken from the oven and cooled. Thereafter, the haze of the cooled sample was measured.

2. Evaluation of Adhesion Degree

The adhesion degree between the film base 11 and the polymer layer 12 was evaluated as follows. Note that, the evaluation of adhesion degree was made as to a sample taken from the film base 11 on which the polymer layer 12 was formed but the conductive layer 13 was not formed yet. The sample was soaked in distilled water at the temperature of 60° C. for 16 hours. Next, the sample after being soaked was taken from the distilled water, and water drops adhered to a surface of the sample were wiped lightly by a piece of paper (manufactured by NIPPON PAPER CRESIA Co., LTD, trade name: Kimwipe S-200). Immediately after the water drops adhered to the surface of the sample were wiped, the surface of the sample was scratched by a diamond stylus of 0.1R with use of a scratch resistance strength tester (produced by Shinto Scientific Co. ,Ltd., trade name: HEIDON-18). The scratched area was observed by a microscope with magnification of 100 times. A load applied to the diamond stylus was set to 200 g. The surface of the sample was checked with eyes and the condition of the peeled polymer layer 12 was evaluated based on an evaluation standard mentioned below. Thereby, the adhesion degree between the film base 11 and the polymer layer 12 was evaluated by five stages. Note that, in the below evaluation standard, if the product is evaluated as rank A or B, the level thereof is adequate.

Rank A: No peeling.

Rank B: The peeled area was more than 0% and less than 30% of the whole area scratched by the diamond stylus.

Rank C: The peeled area was equal to or more than 30% and less than 70% of the whole area scratched by the diamond stylus.

Rank D: The peeled area was equal to or more than 70% and equal to or less than 100% of the whole area scratched by the diamond stylus.

Rank E: In addition to the area scratched by the diamond stylus, periphery of the scratched area of the polymer layer 12 was also peeled.

3. Whether or not Rainbow Unevenness Occurred

Whether or not rainbow unevenness occurred was evaluated as follows. First of all, a surface of the film base 11 of the obtained conductive film 10 opposite to a surface to be observed, namely, a surface of the film base 11 of the obtained conductive film 10 not having the conductive layer 13 was rubbed with sand paper adequately, and then a magic marker (manufactured by Shachihata Inc., trade name: artline oil-based marker, refill ink of KR-20 black) was applied to the rubbed surface and dried. Thus, adjustment for preventing reflection of light on the surface of the film base 11 was performed, such that transmittance of light at the wavelength of 500 nm was at most 1%. Thereafter, the sample was put on a disk such that the film base 11 of the sample was made in contact with the disk, namely, such that the conductive layer 13 was exposed outside. Then, the sample was illuminated with a three-wavelength fluorescent lamp (product name: National PALOOK fluorescent lamp, FL20S•EX-D/18) from above with keeping a distance of 30 cm to cause interference fringe, and the interference fringe was observed with eyes. The interference fringe recognized in the observation was considered as rainbow unevenness, and evaluation was made as to whether or not rainbow unevenness occurred and the degree of the rainbow unevenness based on the below evaluation standard by three stages. Note that, in the below evaluation standard, if the product is evaluated as rank A or B, the level thereof is adequate.

Rank A: No rainbow unevenness was recognized when the sample was observed from any angle including a front side of the sample.

Rank B: No rainbow unevenness was recognized when the sample was observed from the front side thereof, however slight rainbow unevenness was recognized when the sample was observed from angles other than the front side thereof.

Rank C: Rainbow unevenness was recognized even when the sample was observed from the front side thereof.

4. Whether or not Deposition of Oligomer Occurred

Whether or not deposition of oligomer occurred was evaluated as follows. A sample was taken from the obtained conductive film 10, and the sample was heated under the same condition as that for the measurement of the amount of change in haze. After the sample was taken from the oven and cooled, it was observed whether or not there was change between the appearance of the sample before the heating and the appearance of the sample after the heating. The evaluation standard was as follows.

A: No change was observed.

B: The sample after the heating was slightly clouded.

C: The sample after the heating was clouded or had white spots.

Note that, the conductive films 10 and 20 obtained in each of the following examples and the conductive films obtained in the comparative examples were evaluated in the same manner as Example 1. The evaluation results of the examples are shown in Table 1, and the evaluation results of the comparative examples are shown in Table 2.

### EXAMPLE 2

The first coating liquid 33 having the composition A was substituted with the first coating liquid 33 having the following composition B. Other conditions of Example 2 were the same as those of Example 1.

<First Coating Liquid 33 having Composition B>

| | |
|---|---|
| Polyester (binder component) having a refractive index of | 57.63 pts. mass |
| at least 1.60 (manufactured by Goo Chemical CO, Ltd., trade name: | |
| Plas coat Z-687, solid content of 25%) | |
| Compound having a plurality of carbodiimide structures | 28.31 pts. mass |
| (manufactured by Nisshinbo Chemical Inc., trade name: Carbodilite | |
| V-02-L2, solid content of 40%) | |
| Surfactant A (manufactured by NOF CORPORATION, aqueous | 12.86 pts. mass |
| solution containing 1% of Rapizol B-90, anionic) | |
| Surfactant B (manufactured by Sanyo Chemical Industries, | 15.49 pts. mass |
| Ltd., aqueous solution containing 1% of Naroacty CL-95, nonionic) | |
| Zirconium oxide sol (manufactured by NISSAN CHEMICAL | 28.16 pts. mass |
| INDUSTRIES, LTD., trade name: ZR-40BL, average diameter of the | |
| particles of 0.007 μm, and solid content of 40%) | |

Distilled water added such that total amount of the first coating liquid 33 became 1000 parts by mass.

### EXAMPLE 3

The conductive film 20 was produced by the conductive film producing apparatus 31. The second coating liquid 37 was applied to the polymer layer 12 formed in the same manner as Example 1, to be the coating layer on the polymer layer 12. The second coating liquid 37 was UV curable polymer (manufactured by JSR Corporation, trade name: Z7410B, refractive index of 1.65) . The second coating liquid 37 was applied to the polymer layer 12 such that the thickness of the coating layer of the second coating layer 37 became approximately 9 μm. Thereafter, the coating layer was heated at the temperature of 70° C. to be dried for 1 minute. Next, UV rays were irradiated to the dried coating layer with use of a high pressure mercury lamp to harden the polymer in the coating layer, thus obtaining the hard coat layer 21 having a thickness of 3 μm. Note that, the amount of the UV rays irradiated to the coating layer was set to 1000 mJ/cm².

The ITO layer as the conductive layer 13 was formed on the hard coat layer 21 in the same manner as Example 1. The refractive index of the conductive layer 13 thus formed was 2.05, and the thickness thereof was 30 nm.

### COMPARATIVE EXAMPLE 1

There was prepared a coating liquid having the same composition as the composition A of the first coating liquid 33 of Example 1 without containing aqueous dispersion in which acicular composite metal oxide of tin dioxide and antimony was dispersed in water. The prepared coating liquid was used instead of the first coating liquid 33 having the composition A. Other conditions for producing the conductive film were the same as those of Example 1.

### COMPARATIVE EXAMPLE 2

There was prepared a coating liquid having the same composition as the composition A of the first coating liquid 33 of Example 1 without containing aqueous dispersion in which acicular composite metal oxide of tin dioxide and antimony was dispersed in water. The prepared coating liquid was used instead of the first coating liquid 33 having the composition A. Other conditions for producing the conductive film were the same as those of Example 3.

### COMPARATIVE EXAMPLE 3

A coating liquid having the following composition C was used instead of the first coating liquid 33 of Example 1. Other conditions were the same as those of Example 1.

<Coating Liquid having the Composition C>

| | |
|---|---|
| Polyester (binder component) (manufactured by ISHIHARA | 49.68 pts. mass |
| SANGYO KAISYA, LTD., trade name: ES-650, solid content of 29%) | |
| Compound having a plurality of carbodiimide structures | 28.31 pts. mass |
| (manufactured by Nisshinbo Chemical Inc., trade name: Carbodilite | |
| V-02-L2, solid content of 40%) | |
| Surfactant A (manufactured by NOF CORPORATION, aqueous | 12.68 pts. mass |
| solution containing 1% of Rapizol B-90, anionic) | |
| Surfactant B (manufactured by Sanyo Chemical Industries, | 15.49 pts. mass |
| Ltd., aqueous solution containing 1% of Naroacty CL-95, nonionic) | |
| Aqueous dispersion in which acicular composite metal oxide | 132.39 pts. mass |
| of tin dioxide and antimony is dispersed in water (manufactured | |
| by ISHIHARA SANGYO KAISYA, LTD., trade name: FS-10D, | |
| solid content of 20%) | |

Distilled water added such that total amount of the coating liquid became 1000 parts by mass.

### EXAMPLE 4

A coating liquid having the following composition D was used instead of the first coating liquid 33 having the composition A. Other conditions were the same as those of Example 1.

<Coating Liquid having Composition D>

| | |
|---|---|
| Polyester (binder component) (manufactured by Goo Chemical | 57.63 pts. mass |
| CO, Ltd., trade name: Plas coat Z-687, solid content of 25%) | |
| Compound having a plurality of carbodiimide structures | 28.31 pts. mass |
| (manufactured by Nisshinbo Chemical Inc., trade name: Carbodilite | |
| V-02-L2, solid content of 40%) | |
| Surfactant A (manufactured by NOF CORPORATION, aqueous | 12.68 pts. mass |
| solution containing 1% of Rapizol B-90, anionic) | |
| Surfactant B (manufactured by Sanyo Chemical Industries, | 15.49 pts. mass |
| Ltd., aqueous solution containing 1% of Naroacty CL-95, nonionic) | |
| Aqueous dispersion in which acicular composite metal oxide | 60.36 pts. mass |
| of tin dioxide and antimony is dispersed in water (manufactured | |
| by ISHIHARA SANGYO KAISYA, LTD., trade name: SN-38F, average | |
| diameter of the particles of 0.055 μm, content of antimony oxide | |
| of 5.9%, solid content of 17%) | |

Distilled water added such that total amount of the coating liquid became 1000 parts by mass.

In Tables 1 and 2, EX denotes Example, COM denotes comparative example, RI denotes refractive index, EV denotes evaluation, TLT denotes total light transmittance, and ACH denotes amount of change in haze.

TABLE 1

| | | | EX 1 | EX 2 | EX 3 | EX 4 |
|---|---|---|---|---|---|---|
| Film | RI (η1) | | 1.65 | 1.65 | 1.65 | 1.65 |
| base | | | | | | |
| Polymer | RI (η2) | | 1.65 | 1.66 | 1.65 | 1.65 |
| layer | RI of Binder (ηB) | | 1.63 | 1.63 | 1.63 | 1.63 |
| | RI of Particles | | 1.91 | 1.84 | 1.91 | 1.86 |
| | (ηP) | | | | | |
| | (MP/MB) × 100 | | 67 | 78 | 67 | 71 |
| | (wt %) | | | | | |
| \|η1 − η2\| | | | 0.00 | 0.01 | 0.00 | 0.00 |
| Functional layer | | | Without | Without | With | Without |
| EV | Transparency | TLT (%) | 87 | 83 | 84 | 84 |
| | | ACH (%) | 0.1 | 0.1 | 0.1 | 0.1 |

| | | | | |
|---|---|---|---|---|
| Adhesion degree | A | A | A | A |
| Whether or not rainbow | A | A | B | A |
| unevenness occurred | | | | |
| Whether or not deposition | A | A | A | A |
| of oligomer occurred | | | | |

TABLE 2

| | | | COM 1 | COM 2 | COM 3 |
|---|---|---|---|---|---|
| Film base | RI (η1) | | 1.65 | 1.65 | 1.65 |
| Polymer layer | RI (η2) | | 1.60 | 1.60 | 1.65 |
| | RI of Binder (ηB) | | 1.63 | 1.63 | 1.56 |
| | RI of Particles | | — | — | 1.91 |
| | (ηP) | | | | |
| | (MP/MB) × 100 (wt %) | | — | — | 183 |
| \|η1 − η2\| | | | 0.05 | 0.05 | 0.00 |
| Functional layer | | | Without | With | Without |
| EV | Transparency | TLT (%) | 70 | 69 | 76 |
| | | ACH (%) | 0.5 | 0.5 | 0.7 |

| | | | |
|---|---|---|---|
| Adhesion degree | A | A | C |
| Whether or not rainbow | C | C | A |
| unevenness occurred | | | |
| Whether or not deposition | B | B | C |
| of oligomer occurred | | | |

Although there were slight differences in conditions including the kinds of binder, particles, and the like among Examples 1 to 3, the value of |η1−η2| was set to at most 0.02 in all of the Examples 1 to 3, and therefore, the obtained product was evaluated to be excellent enough to be used in each of the evaluation items described above. Additionally, when each of the obtained conductive films 10 and 20 was wound into a film roll and an end face of the film roll was observed, the end face was not bluish. In view of the above, it was confirmed that each of the obtained conductive films 10 and 20 had excellent transparency. In contrast, in comparative examples 1 and 2, no particles of metal oxide were added, and the value of |η1−η2| was set to 0.05. Therefore, although the obtained product was evaluated to be satisfactory in the evaluation regarding the adhesion degree, the obtained product was evaluated to be unsatisfactory in the evaluation regarding the rainbow unevenness and the deposition of oligomer in association with the transparency.

In comparative example 3, the binder had the glass transition temperature Tg of at most 90°, and the refractive index of less than 1.6. Therefore, although the obtained product was evaluated to be satisfactory in the evaluation regarding the rainbow unevenness, the obtained product was evaluated to be unsatisfactory in the evaluation regarding the adhesion degree and the deposition of oligomer in association with the transparency.

In example 4, the particles of metal oxide having the content of antimony oxide of at least 5% was used, and therefore, the obtained product was evaluated to be satisfactory. However, when the conductive film was wound into a film roll and the end face of the film roll was observed, the end face was slightly bluish.

Various changes and modifications are possible in the present invention and may be understood to be within the present invention.

What is claimed is:

1. A transparent conductive film comprising:
a film base formed from polyester and biaxially stretched;
a polymer layer formed on one of surfaces of said film base and containing particles of metal oxide having a refractive index ηP of at least 1.80 and a binder holding said particles and having a refractive index ηB of at least 1.60, a mass ratio of said particles with respect to said binder being at most 100%, and a difference between a refractive index η1 of said film base and a refractive index η2 of said polymer layer being at most 0.02; and
a transparent conductive layer formed on said polymer layer.

2. A transparent conductive film as defined in claim 1, wherein said metal oxide includes tin oxide and antimony oxide, and when mass of said tin oxide is denoted by M1 and mass of said antimony oxide is denoted by M2, a content of said antimony oxide with respect to said tin oxide obtained by (M2/M1)×100 is more than 0 mass % and equal to or less than 5 mass %.

3. A transparent conductive film as defined in claim 2, wherein a thickness of said polymer layer is in a range of {500/(4×η2)}nm or more and {600/(4×η2)}nm or less.

4. A transparent conductive film as defined in claim 3, wherein a glass transition temperature Tg of polymer as said binder is at least 90° C.
